(19) United States
(12) Patent Application Publication
(10) Pub. No.: US 2009/0172631 A1
(43) Pub. Date: Jul. 2, 2009

(54) Method Of Adding A Functionality To An Executable First Module Of A Program Package

(75) Inventors: Michael Zunke, Kirchheim (DE); Andreas Lange, Munchen (DE)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN EUROPE GMBH, Germering (DE)

(21) Appl. No.: 11/719,753

(22) PCT Filed: May 5, 2006
(86) PCT No.: PCT/EP06/04234

§ 371 Date: May 21, 2007

(30) Foreign Application Priority Data
May 6, 2005 (EP) 05009912.6
May 6, 2005 (EP) 05009913.4

(51) Int. Cl. G06F 9/44

(52) U.S. Cl. 717/100

(57) ABSTRACT

What is provided is a method of adding a functionality to an executable first module of a program package, wherein the executable first module, during execution, provides an internal function or utilizes an internal function of an executable second module of the program package;
wherein, when the first module is not executed, an externally visible reference pointing to said internal function is determined,
auxiliary code is added to the first module and
a redirection is permanently provided in the first module as a function of the reference thus determined such that a modified executable first module is present, wherein, when the internal function is requested during execution, a redirection is made to the auxiliary code which causes the functionality to be provided during execution.

The invention relates to a method of adding a functionality to an executable first module of a program package, wherein said executable first module, during execution, provides an internal function or utilizes an internal function of an executable second module of the program package.

In order to incorporate an additional functionality into such a first module of a program package, which functionality hooks in at the location of the provided or utilized function, it has been required so far to possess the source code of at least the first module in order to be able to perform the desired modifications therein.

In view of the above, it is the object of the invention to provide a method of adding a functionality to an executable first module of a program package, wherein said executable first module, during execution, provides an internal function or utilizes an internal function of an executable second module of the program package, said method allowing the functionality to be added without knowledge of the source code of the first module.

According to the invention, the object is achieved by a method of adding a functionality to an executable first module of a program package, wherein said executable first module, during execution, provides an internal function or utilizes an internal function of an executable second module of the program package, wherein, when the module is not executed, an externally visible reference pointing to said internal function is determined, auxiliary code is added to the first module and a redirection is permanently provided in the first module as a function of the reference thus determined, such that a modified executable first module is present, wherein, when the internal function is called during execution, a redirection is made to the auxiliary code which causes the functionality to be provided during execution.

Thus, the method utilizes the presence of an externally visible reference of the function. This reference is used as a point of application for redirection to the added auxiliary code, so that the added auxiliary code at this site gains control over the execution, thereby allowing the desired functionality to be realized by means of the auxiliary code.

An executable module is understood herein to be any module which is present for the runtime environment (for example, hardware plus corresponding operating system) in a form merely requiring it to be loaded into the memory of the computer or of the runtime environment, to be initialized, where appropriate, and to be started, so as to execute it. The module may run on its own (executable module) or may require further executable modules for its execution (dependently executable module). In particular, the module may be present in compiled form. In Windows operating systems, the executable module may be an EXE file or a DLL file. In the case of the net environment of Microsoft or any other object-oriented environment, the module may be a so-called assembly, a class library or a class, and in the case of UNIX-based operating systems, the module may be, for example, a shared library. The first and second executable modules may be present in the same file or also as separate files.

An internal function is understood herein to be any function of the first or second modules, respectively, which may be requested (called) during execution of the program package. However, this does not refer to the starting of the application itself or, for example, to initialization of a DLL file, respectively. The starting of the application and the initialization of a DLL file has to be carried out by the runtime environment (for example, the operating system) and is, therefore, not an internal function in the sense used herein.

The redirection (rerouting) is preferably provided such that the auxiliary code is inserted into the executive path of the internal function. In particular, said code is inserted at the start of the executive path of the internal function. A further insertion of the auxiliary code may be present at the end of the executive path. This may be used, for example, to encrypt the corresponding code again after execution of the function, if said code has been decrypted by means of the auxiliary code at the start of the function. Insertion at the end may be realized by changing the return address at the stack which was stored during the request.

Thus, the method according to the invention allows to insert auxiliary code to the first module for each internal function of the first or second modules, via the externally visible reference, said auxiliary code being executed before execution of the internal function and thus providing a desired functionality. Said functionality may be, for example, that of licensing this function. Thus, it is possible to individually license functions of a program package without knowledge of the source code or of the practical realization of the function, respectively. In particular, the method according to the invention also allows, for example, to subsequently provide a dependent, operable module (for example, a DLL file in compiled form) or the function provided by said module with, for example, the functionality of license verification and to transmit the thus modified, operable (or executable) module to a user. This makes very flexible licensing of individual functions of an application possible subsequently (i.e. after completion of the application). For this purpose, suitable function requests had to be provided hitherto during programming of the application, which is complex and is therefore not common practice. Using the method according to the invention, it is now possible to provide individual licensing for a finished program package due to the possibility according to the invention of subsequent, individual addition of a functionality to a function of the program package.

Determination of the reference is effected, in particular, when the first module is loaded into a computer, but not for execution of the module in the computer. The first module may be stored, for example, in a single file. In this case, the loading of the first module corresponds e.g. to the opening of the file (but not the execution of the file in the computer). The process steps according to the invention are performed on the opened file and then the modifications are saved in the file, so that the modified first module is present.

The modified executable first module comprising the permanently provided redirection thus comprises said redirection already at the time when the module is being loaded into a computer system in order to execute it. Therefore, no modifications with respect to the redirection are required for the modified first module when it is being loaded into the computer system for execution.

The externally visible reference can be present as a meta datum or as meta data. Meta data are understood herein, for example, to be auxiliary data which the runtime environment needs in order to be able to load the module into the memory, to initialize and/or to start it, but which the code of the module itself does not need. Meta data include, in particular, information on the starting point of the internal function (e.g. map files, debug information and profiler information). Meta data may also be data from which the starting point of the internal function can be derived, but which are needed neither by the runtime environment nor by the code of the module in order to execute the module. The meta data may be contained in the program package and/or may be provided separately.

The reference may be determined on the basis of at least one meta datum which is part of the executable program package. This may be, for example, an entry in the import and/or export table or, for example, the pointer pointing to an entry point of a class in object-oriented programming.

The reference may be determined on the basis of at least one meta datum which is not part of the executable program and has been generated during the making of the first and/or second module. This may be, for example, debug and/or profiler information generated during the making of the program package. Use may also be made of so-called map files.

The first module may comprise meta data in an import table in which a pointer pointing to the function of the second module is stored as a reference, the redirection to the added auxiliary code being stored in the import table during the modification step or when providing the redirection, respectively. Thus, the desired redirection can be permanently inserted into the first module in a simple manner.

Further, the second module may comprise an export table as meta data, in which export table a pointer pointing to the starting point of the function in the second module is stored as a reference, the redirection to the added auxiliary code being stored in the export table during the modification step or when providing the redirection, respectively. In this case, a simple and permanent redirection is possible, too.

In particular, it is possible to redirect a conventional export/import interface between two modules via the added auxiliary code and to thereby provide the desired additional functionality.

The first module may comprise an import table in which a pointer pointing to the function of the second module is stored as a reference, the import table being modified or erased (or the pointer pointing to the function being erased, respectively) in a modification step, and the request of the function in the first module being redirected to the auxiliary code. Thus, no import to the internal function of the second module is contained as an externally visible reference in the first module anymore. This may serve to increase security, for example, if the first module is protected against unauthorized use by the second module (e.g. in the form of license verification), because the auxiliary code may be used to check that the second module, which performs license verification, has not been replaced by a different module.

The added auxiliary code may establish an interface between the two modules when starting the program package or the first module, respectively. In particular, this interface may be one which is protected and is not visible from the outside.

The auxiliary code may be designed such that the one interface between the two modules is established only upon request of the function. In this case, too, the interface may be embodied such that it is not visible from the outside and thus represents a secure connection between the two modules.

In particular, auxiliary code may be inserted, which auxiliary code ensures, when it is being executed, that a connection between the two modules is present without interposition of further modules. This is advantageous, in particular, when adding the functionality of a license verification, because this allows to exclude that an attacker interposes a module by which the license verification is spied out and thus made ineffective.

In order to provide the redirection to the added auxiliary code, further code can be provided in that region of the second module where instructions of the provided function are located, which further code refers to the added auxiliary code. The further code is located, in particular, in the starting region of the function (e.g. the first, second, third, . . . instruction) and is preferably provided such that it overwrites code of the function. The auxiliary code may contain a return instruction which points to an instruction of the function following the overwritten code.

As an alternative, it is possible to integrate the redirection as well as the code realizing the function into the first module. This code may be that of the second module or a code realizing the internal function. This has the advantageous effect that no externally visible interface between the two modules is present anymore.

The functionality may be, in particular, protection of an interface between two modules. This is used, in particular, for subsequent protection of the program against unauthorized use. Further, said functionality may be a verification of the license of at least one of the modules. Said functionality may also consist in that the first and/or second module is encrypted at least partially and that decryption is effected by means of the auxiliary code. Decryption is preferably effected only if a previous license verification has confirmed the presence of a license. If no license is present, no decryption is effected so that the program package can not be executed.

The program package may comprise several second modules having several different functions, which are each embedded with an externally visible reference in the executive path, wherein each of said functions can be redirected, as described above, via the auxiliary code. The same applies, if a second module provides several functions which are again embedded in the executive path by means of an externally visible reference.

The method may further comprise the step of manufacturing the executable program package (including the not yet modified first module), wherein manufacture is effected such that the externally visible reference to the function is generated thereby. Said manufacture may consist, for example, in compiling the source code from which the executable first module is generated. For this purpose, for example, meta data (e.g. import/export information) conventionally generated during compiling may be used. Further, it is possible to influence manufacture such that additional meta data are generated. Thus, an export may be inserted into the module to be compiled such that in the compiled and thus executable module a pointer pointing to the start of the function is contained in an export table. Said export is then recognized as a reference in the determining step, the reference in the export table to the function or the entire export table being preferably deleted during modification of the executable module. In this case, the module thus modified will then no longer contain, for example, the externally visible reference to said function.

The executable first module of the program package can provide the function, including the externally visible reference, to the executable second module, which module uses the function during initialization even prior to execution of the first instruction of the first module.

This is the case, for example, when the first module is an executable application and the second module is a DLL file (in Windows operating systems). When starting the application, the operating system first loads the executable application into the main memory of the computer on which the application is to be executed and then loads the DLL file. This is then followed by the initialization for the DLL file, wherein the function provided by the executable application is executed, and only after this is the executable application started.

In order to protect the executable application against unauthorized use, one may encrypt the application, for example, said decryption, however, being usually effected only with the start of the executable application itself. This means that, when utilizing the function provided by the executable application during initialization of the DLL file, the function is still present in encrypted form and can therefore not be used, so that an error message appears and the application is not executed.

In order to avoid this problem it has hitherto been estimated in which region of the executable application the provided function is located, leaving this region out during encryption. However, this is complex, on the one hand, and very inaccurate, on the other hand, and disadvantageously leads to further regions of the application being present in unencrypted form.

According to the invention, in order to solve this problem—if the functionality to be added relates to protecting the first module—at least part of the code realizing said function of the first module is encrypted when the first module is not being executed, such that a modified first module is present in which, when the program package including the modified first module is being executed, the executive path is redirected to the added code due to said redirection when requesting said function, which added code, during its execution, decrypts the encrypted code of the function such that the function can be executed.

Thus, the method according to the invention uses the fact that the function provided by the first module comprises an externally visible reference from which the starting point (entry point) of the function in the first module can be derived, although the first module is already present as an executable module, i.e. usually in compiled form or in machine code, respectively. Using said reference, a redirection is incorporated into the first module, which redirection causes the added code to gain control over the first module before the latter is started by the operating system, i.e. before the starting instruction of the first module is executed. This makes it possible to encrypt also the code of the first module realizing the function, because even if the function is requested before starting the first module, the redirection causes execution of the added code which executes the required decryption of the corresponding instructions of the function of the first module.

Thus, it is possible to encrypt a first executable module providing a function to a second executable module, and to protect it thereby against unauthorized use, even if the function of the first module is used before its first execution.

Of course, the method allows encryption of the entire code of the function or even of the entire first module.

The added code may, of course, also have the effect that, after execution of the function, the code decrypted for this purpose is encrypted again. This increases the security against unauthorized use of the protected application.

The steps according to the invention are preferably carried out prior to execution of the modules such that the code and the redirection are added in a lasting (permanent) manner.

An executable module is understood herein to be any module which is present for the runtime environment (for example, hardware plus corresponding operating system) in a form merely requiring it to be loaded into the memory of the computer or of a runtime environment, to be initialized, where appropriate, and to be started, so as to execute it. The module may run on its own (executable module) or may require further executable modules for its execution (dependently executable module). In particular, the module may be present in compiled form. In Windows operating systems, the executable module may be an EXE file or a DLL file. In the case of the .net environment of Microsoft or any other object-oriented environment, the module may be a so-called assembly, a class library or a class, and in the case of UNIX-based operating systems, the module may be, for example, a shared library. The first and second executable modules may be present in the same file or also as separate files.

The externally visible reference can be present as a meta datum or as meta data. Meta data are understood herein, for example, to be auxiliary data which the runtime environment needs in order to be able to load the module into the memory, to initialize and/or to start it, but which the code of the module itself does not need. Meta data include, in particular, information on the starting point of the function. Meta data may also be data from which the starting point of the internal function can be derived, but which are needed neither by the runtime environment nor by the code of the module in order to execute the module. The meta data may be contained in the program package and/or may be provided separately.

The first module may comprise meta data in the form of an export table in which a pointer pointing to the starting point of the function in the first module is stored as a reference. The export table is evaluated by the runtime environment during loading of the first module in order to ensure the possibility of calling the function by other modules also loaded into the memory. In a further embodiment of the method according to the invention, the redirection to the added code is stored in the export table. Thus, the desired redirection can be permanently inserted into the first module in a simple manner.

It is further possible to use the externally visible reference to determine that region in the first module in which instructions of the provided function are located and to provide further code there pointing to the added code. In particular, part of the original code can be replaced by the further code. The further code is inserted, in particular, at the beginning of the function (e.g. the first, second, third . . . instruction). The further code (auxiliary code) may comprise a return instruction which points to an instruction of the function following the replaced code.

To the first module there can be added code which carries out a license verification before decryption and only allows decryption if the presence of a license is determined during license verification. Thus, protection against unauthorized execution of the first module is realized.

Code may be added, which stores data transmitted upon request of the function and transmits these to the function after decryption. This ensures correct execution of the function.

The added code may further contain a return instruction which points to the decrypted function. Again, this ensures execution of the function after decryption has been effected.

Further, a method of protecting an executable first module of a program package is provided, wherein the first module provides a function, including an externally visible reference, to an executable second module, which module uses the function during its initialization even prior to execution of the first module, in which method at least part of the code realizing said function of the first module is encrypted, executable code is added to the first module and a redirection to the added code is provided in the first module on the basis of the reference such that a modified first module is present in which, when the program package including the modified first module is being executed, the executive path is redirected to the added code due to said redirection when requesting said function, which added code, during its execution, decrypts the encrypted code of the function such that the function can be executed.

Thus, use is made of the fact that the function provided by the first module comprises an externally visible reference from which the starting point of the function in the first module can be derived, although the first module is already present as an executable module, i.e. usually in compiled form or in machine code, respectively. Using said reference, a redirection is incorporated into the first module which redirection causes the added code to gain control over the first module before the latter is started by the operating system, i.e. before the starting instruction of the first module is executed. This makes it possible to encrypt also the code of the first module realizing the function, because even if the function is requested before starting the first module, the redirection causes execution of the added code which executes the required decryption of the corresponding instructions of the function of the first module.

Thus, it is possible to encrypt a first executable module providing a function to a second executable module, and to protect it thereby against unauthorized use if the function of the first module is used before its first execution.

Of course, the method allows encryption of the entire code of the function or even of the entire first module.

The steps according to the invention are preferably carried out prior to execution of the modules such that the code and the redirection are added in a lasting (permanent) manner.

An executable module is understood herein to be any module which is present for the runtime environment (for example, hardware plus corresponding operating system) in a form merely requiring it to be loaded into the memory of the computer or of the runtime environment, to be initialized, where appropriate, and to be started, so as to execute it. The module may run on its own (executable module) or may require further executable modules for its execution (dependently executable module). In particular, the module may be present in compiled form. In Windows operating systems, the executable module may be an EXE file or a DLL file. In the case of the net environment of Microsoft or other object-oriented environments, the module may be a so-called assembly, a class library or a class, and in the case of UNIX-based operating systems, the module may be, for example, a shared library. The first and second executable modules may be present in the same file or also as separate files.

The externally visible reference can be present as a meta datum or as meta data. Meta data are understood herein, for example, to be auxiliary data which the runtime environment needs in order to be able to load the module into the memory, to initialize and/or to start it, but which the code of the module itself does not need. Meta data include, in particular, information on the starting point of the function. Meta data may also be data from which the starting point of the internal function can be derived, but which are needed neither by the runtime environment nor by the code of the module in order to execute the module. The meta data may be contained in the program package and/or may be provided separately.

The first module may comprise meta data in the form of an export table in which a pointer pointing to the starting point of the function in the first module is stored as a reference. The export table is evaluated by the runtime environment during loading of the first module in order to ensure the possibility of calling the function by other modules also loaded into the memory. In a further embodiment of the method according to the invention, the redirection to the added code is stored in the export table. Thus, the desired redirection can be permanently inserted into the first module in a simple manner.

It is further possible to use the externally visible reference to determine that region in the first module in which instructions of the provided function are located and to provide further code there pointing to the added code. In particular, part of the original code can be replaced by the further code. The further code is inserted, in particular, at the beginning of the function (e.g. the first, second, third . . . instruction). The auxiliary code may comprise a return instruction which points to an instruction of the function following the replaced code.

To the first module there can be added code which carries out a license verification before decryption and only allows decryption if the presence of a license is determined during license verification. Thus, protection against unauthorized execution of the first module is realized.

Code may be added, which stores data transmitted upon request of the function and transmits these to the function after decryption. This ensures correct execution of the function.

The added code may further contain a return instruction which points to the decrypted function. Again, this ensures execution of the function after decryption has been effected.

Further, a computer program product is provided which comprises software code for carrying out the steps of the method according to the invention or of its further embodiments, when the product is being executed on a computer.

The invention will be described in more detail below, by way of example and with reference to the Figures, wherein:

FIG. 1 shows a schematic representation of an executable program package;

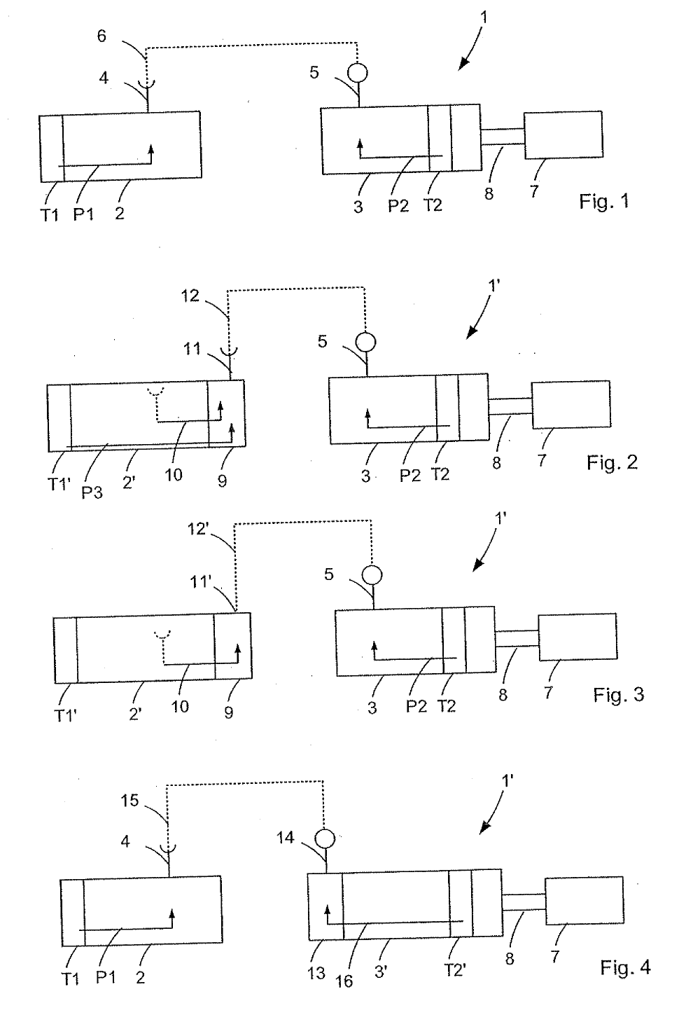

FIG. 2 shows a schematic representation of adding a functionality to a program package of FIG. 1 according to a first embodiment;

FIG. 3 shows a schematic representation of adding a functionality to a program package of FIG. 1 according to a second embodiment;

FIG. 4 shows a schematic representation of adding a functionality to a program package of FIG. 1 according to a third embodiment;

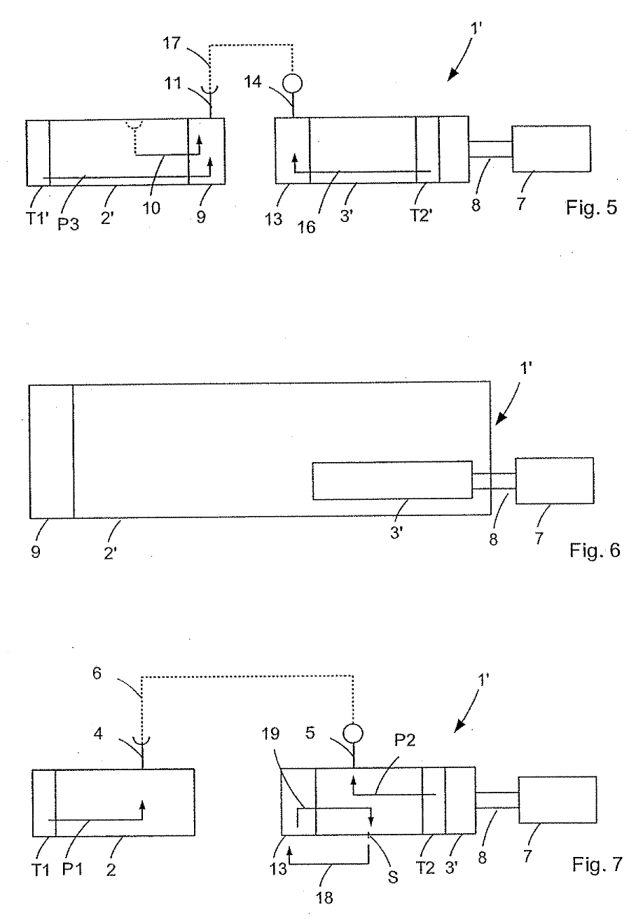

FIG. 5 shows a schematic representation of adding a functionality to a program package of FIG. 1 according to a fourth embodiment;

FIG. 6 shows a schematic representation of adding a functionality to a program package of FIG. 1 according to a fifth embodiment;

FIG. 7 shows a schematic representation of adding a functionality to a program package of FIG. 1 according to a sixth embodiment;

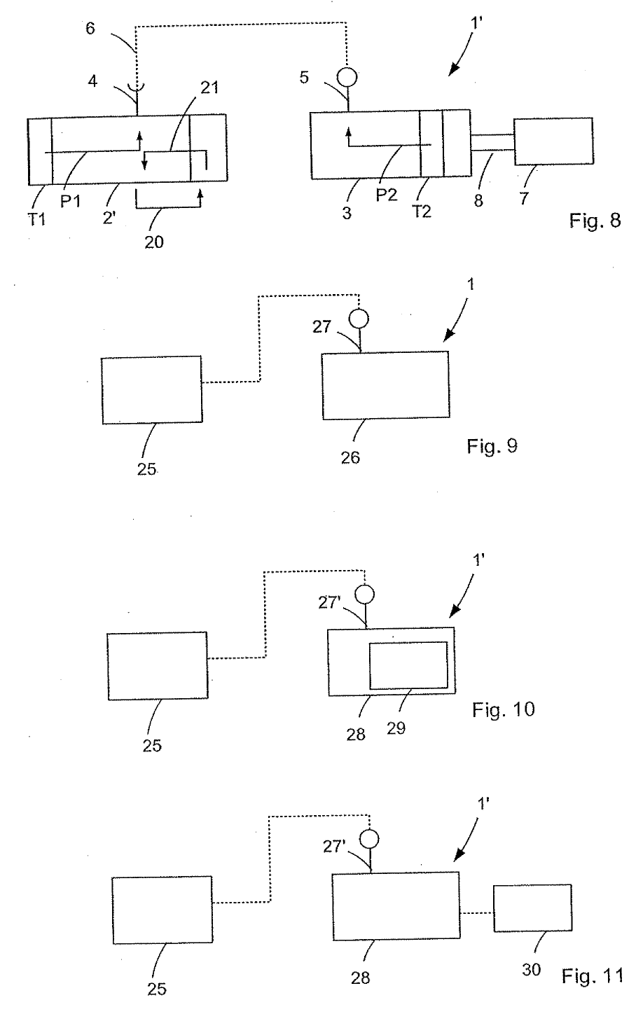

FIG. 8 shows a schematic representation of adding a functionality to a program package of FIG. 1 according to a seventh embodiment;

FIG. 9 shows a schematic representation of a further program package;

FIG. 10 shows a schematic representation of the program package of FIG. 9 with an added functionality;

FIG. 11 shows a schematic representation of the modified program package of FIG. 10 during execution;

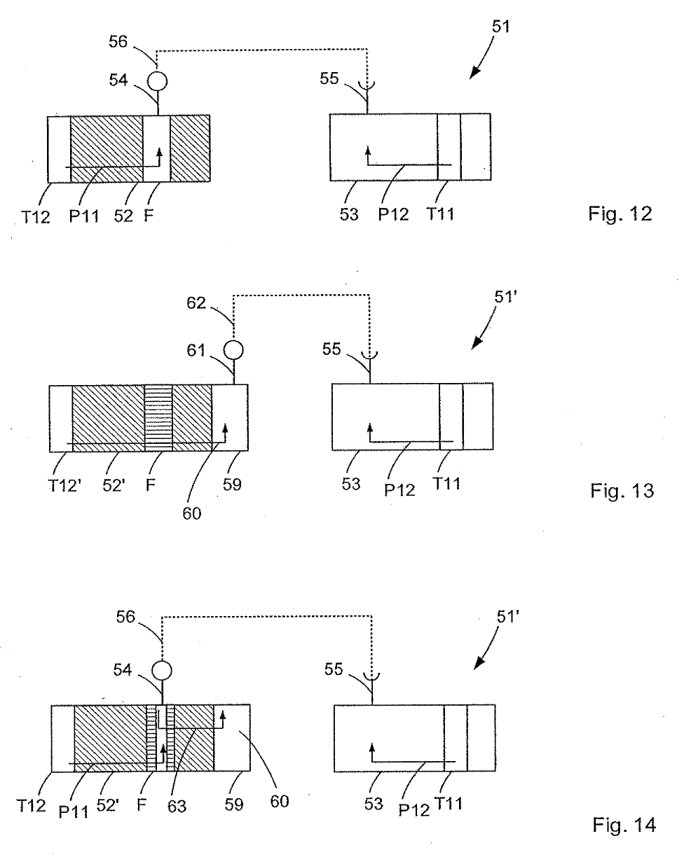

FIG. 12 shows a schematic view of two modules of an application to be protected;

FIG. 13 shows a schematic view of the protected application of FIG. 12;

FIG. 14 shows a schematic view of an application of FIG. 12 protected in a different manner;

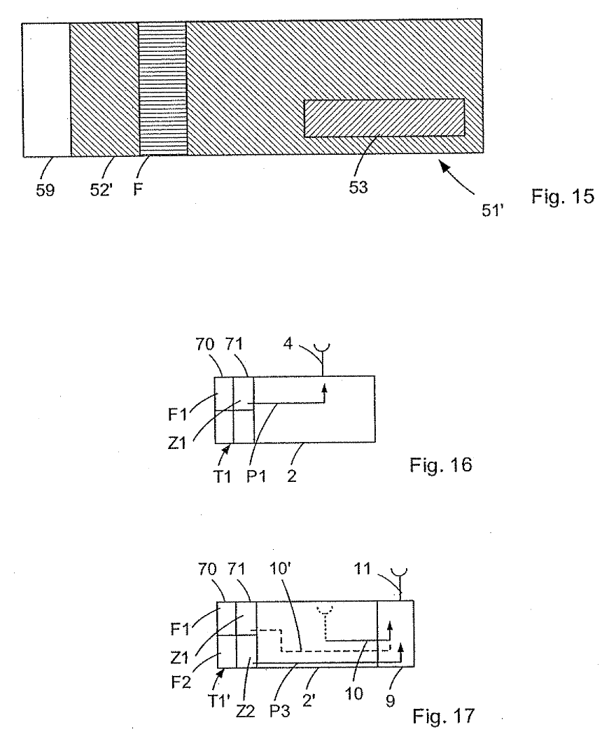

FIG. 15 shows a schematic view of a further possibility of protecting the application of FIG. 12;

FIG. 16 shows a further representation of the application 2 of FIG. 1 explaining the structure of the import table T1, and
FIG. 17 shows a further representation of the application 2 of FIG. 1 explaining the structure of the import table T1′.

As schematically shown in FIG. 1, an executable program package 1 comprises an executable application 2 to be protected (first module, in the form of an EXE file for Windows operating systems in this case) and an executable second module 3 (in the form of a DLL file in this case).

The application 2 as well as the second module 3 are connected via an import/export interface. This is schematically indicated in that the application 2 comprises an import 4 which points to a corresponding export 5 of the second module 3. Thus, a function, which is provided by means of the second module 3 via the import 4 and the export 5, as indicated by the broken line 6, is made available to the application 2 so that the function of the second module 3 is embedded in the executive path of the application 2.

The necessary data or meta data for the import 4 are stored in a known structure (in a so-called import table T1) in the application 2 (indicated here by an arrow P1). In a similar manner, the corresponding data for the export 5 are stored in an export table in a second module 3 (indicated here by an arrow P2). Both the import and the export tables T1, T2 are visible from the outside. This means that, although the application 2 and the second module 3 are present in a compiled and thus executable form, the import and export tables T1, T2 can be read out from the outside without any problem due to the known structure.

In the presently described example, the second module 3 serves to verify the presence of a license for execution of the application 2. For this purpose, a corresponding function in the second module 3 is called by the application 2 via the import 4 and the export 5, and the second module 3 executes the corresponding license verification, for example, with the help of an additional hardware element 7, which communicates with the second module 3 via a secure (not externally visible) connection 8.

In contrast thereto, the import/export connection 6 is a connection which is open to the outside and thus insecure, because the corresponding meta data for the import 4 and the export 5 are stored in the import/export tables.

The open and thus insecure connection via the import 4 and the export 5 is used according to the invention in order to protect the connection between the application 2 and the second module 3. For this purpose, in a modification step, auxiliary code 9 is added to the application 2 and a redirection 10 is provided which redirects the internal request of the import into the auxiliary code 9 such that the import 4 is no longer visible from the outside. This is indicated by the import 4 drawn in broken lines within the application 2. The import table T1 is modified such that it points to the auxiliary code 9 (arrow P3) so that when loading the application, the corresponding address of the function of the second module 3 is registered in the corresponding place in the auxiliary code 9. Thus, there is an import 11 in the region of the auxiliary code 9 and a modified import table T1′. This modification is performed (for example, on the application stored on a data carrier) before execution of the application 2 such that a modified application 2′ is present thereafter (for example, on a data carrier).

In this case, the auxiliary code 9 serves to ensure that there is no unnoticed replacement of the second module 3 with a different module. This may be effected, for example, by verification of a certificate. The import 11 of the auxiliary code 9 may be connected to the export 5 of the second module 3 via a link 12, when the modified program package 1′ is loaded into the working memory of a computer and executed.

In this above-described process of modifying the program package 1 into the program package 1′, an externally visible reference (import 4) of the function of the second module 3 embedded into the executive path of the application 2 is thus used to redirect the executive path via the added code 9. Both the redirection 10 and the added code 9 are permanently added to the application 2 before execution of the application 2 such that a modified application 2′ and, thus, a modified program package 1′ is present, which is executable. This approach has the advantage that the internal operation in the application 2 or in the second module 3 need not be known at all, because in order to redirect the executive path, an externally visible reference (in this case, the import 4) is used for the auxiliary code.

The description given so far in connection with FIGS. 1 and 2 does not provide a detailed discussion of the specific structure or the specific setup, respectively, of the import and export tables T1 and T2, because this setup depends on the respective operating system for which the executable program package 1 is provided. For example, in the Windows XP operating system, the import table T1 comprises two sections 70 and 71, as schematically shown in FIG. 16 which shows the application of FIG. 1 with the structure of the import table T1 for the Windows XP operating system. In the first section 70, which may also be referred to as functional region, e.g. line F1 contains the information for the import 4 indicating from which module the function is being imported (in this case, module 3), which function is being imported from the respective module (in this case, module 3), and where the actual memory address of the starting point of the imported function is to be stored in the second section 71 of the application 2 (in this case, for example, line Z1) when the second module 3 has been loaded for execution into the memory of the computer. The import is schematically indicated here at the logic address in the application 2, at which address the corresponding indirect request A of the imported function is stored as code.

When the application 2 is started by a user, the operating system (in this case, the Windows XP operating system) loads the application 2 into RAMs and initializes it. In doing so, the operating system determines, by means of the first section 70, that a function of the second module 3 is being imported by the application 2. In order to enable this, the operating system now loads the second module 3 into the RAM as well, determines the physical memory address at which the code (or the first instruction, respectively) of the exported function of the second module 3 is located in the RAM and enters the address thus determined into line Z1 of the second section 71. If still further imported functions are entered in the section 70, the same procedure is applied. After the corresponding address entries of the imported function have been entered in the second section 71, the operating system starts the application 2. Now, if during execution the code for the indirect request A is carried out, the corresponding code of the second module 3 is executed by the indirect request via the address entry in line Z1.

Now, in order to realize the redirection 10 of FIG. 2, the entry in line F1 in the functional section 70 is removed and the address of the starting point or entry point, respectively, of the added auxiliary code 9 is statically stored (indicated by broken line 10′) in line Z1 of the second section 71 when the application 2 is not being executed (e. g. in the application stored on a data carrier). In a further line F2 of the functional region 70 (FIG. 17) the information for importing the function of the second module 3 is stored (in the same manner as described above in connection with the import 4) for the (added) import 11, so that the actual memory address of the entry point of the function, when the second module 3 has been loaded for execution into the memory of the computer or of the runtime environment, respectively, is stored in a further line Z2 of the second section 71. Thus, during execution of the modified application 2 the imported function can be called up indirectly (via the address of line Z2) by means of the auxiliary code, in which case, for example, the functionality provided by the added auxiliary code 9 can be realized first.

Thus, the import table T1 (FIGS. 1+16), which comprises the functional region 70 that is itself often referred to as import table in the Windows XP operating system as well as the second section 71 that is also often called import address table in the Windows XP operating system, can be modified as described (modified import table T1′; FIGS. 2+17) in order to realize the desired redirection 10. The subsequently mentioned import tables may also have the described structure.

FIG. 3 shows the case wherein the modification has been effected by deleting the pointer (arrow P1) in the import table T1. In the structure of the import table T1 according to FIGS. 16 and 17, the information in line F1 of the functional region 70 is deleted and the entry point of the auxiliary code 9 is statically entered in line Z1 of the second section 71. However, a new entry in the functional region 70 is not effected, because the connection 12′ is effected without the import table T1′. Thus, in turn, a modified import table T1′ is present. Identical elements in FIG. 3 or identical elements generated by identical steps (as already described) in FIG. 3 have the same reference numerals as in FIG. 2 and are not described again, where appropriate. The same goes accordingly for the following embodiment. The auxiliary code 9 contains the necessary instructions allowing the connection 12′ to the export 5 to be generated via the point 11′ in the executive path in the auxiliary code 9 (in the presently described example, this is not effected via the import table T1′).

The import table T1 may also be completely deleted (not shown), in which case it may be advantageous, however, not to delete it completely and to leave at least a pointer pointing to the second module in the import table T1, because then, the operating system or the runtime environment will execute the necessary initialization (e.g. carrying out the entries in the second section 61 or in the import address table, respectively) when loading the modified program package 1′.

FIG. 4 shows a modified program package 1′, wherein not the import 4 but the export 5 of the second module 3 is redirected via executable auxiliary code 13, which is added to the second module 3 in the modification step, such that a modified second module 3′ is present. In this case, the redirection 16 may be realized in a manner corresponding to the example of FIG. 2 by a corresponding modification of the export table T2 of the second module 3 in the modification step, such that a modified export table T2′ is present. The auxiliary code 13 contains its own export 14, replacing the previous export 5, so that, when requesting the function of the second module 3′, the auxiliary code 13 is first executed, when the modified program package 1′ is loaded into the computer and executed. For example, the auxiliary code 13 can verify who made the request (for example, by means of a signature) and thus prevent the request being made by an application other than the application 2. Thus, spying out of the second module 3′ can be prevented. It can also be excluded that the application 2 to be protected has been replaced by a different application.

By the redirection 16 of the executive path via the additional export 14 of the second module 3′ and the connection 15, a functionality (in this case, checking who requested the second module 3) is added to the program package, without the need to know the internal structure of the second module 3 or of the application 2.

FIG. 5 shows a modified program package 1′, wherein both the import 4 of the application 2 and the export 5 of the second module 3 are each redirected via auxiliary code 9, 13, respectively. Thus, the embodiment of FIG. 5 is a combination of the embodiments of FIGS. 2 and 4, so that the modification steps of FIGS. 2 and 4 are combined in order to go from the program package of FIG. 1 to the modified program package 1′ of FIG. 5. Using the modified program package 1′ of FIG. 5, a secure connection 17 can be realized, for example, because a corresponding encryption and decryption of the data transmitted via the connection 17 can be effected by means of the auxiliary code 9 and 13.

FIG. 6 shows a further modified program package 1′, wherein the second module 3 is completely integrated into the application 2 and the insecure connection 12 is also incorporated into the application 2. This leaves only a modified application 2′, which does not comprise any externally visible and, thus, insecure connection to the second module 3, which is now completely integrated into the application 2. The second module 3 may be incorporated into the application 2 as it is, or the second module 3 is replaced by modified code providing the same function as the second module 3.

In the exemplary embodiments described in FIGS. 2 to 5, the redirection is respectively realized by a modification in the export or import table. A redirection of the executive path in the case of export 5 may also be realized, however, without modifying the export table. Instead, the information in the export table is evaluated such that the starting point S in the second module 3 is determined and at least one instruction at the starting point or following it is partially overwritten by one or more auxiliary code instructions, pointing to the code 13 added to the second module 3, as schematically indicated by the arrow 18 in FIG. 7. The desired functionality is realized with the help of the auxiliary code 13 and then branched back to the original function, as indicated by the arrow 19. Thus, there is a modified second module 3′ also in this case, so that, after performing the described modifications, a modified program package 1′ is present, which comprises the additional functionality resulting from the auxiliary code 13 as compared to the original package 1.

In the same manner, the import 4 of the application 2 can be redirected, as indicated in FIG. 8. In this case, too, the import table is not modified, but an instruction (e.g. the code on which the request of the exported function depends) required for said import is replaced at least partially by an instruction pointing to the auxiliary code 9 added to the application 2, or a branching instruction is inserted in this place, as indicated by the arrow 20. A return instruction is preferably provided in the auxiliary code 9 here as well (arrow 21). Thus, there is a modified application 2′, in which the redirection 20, 21 is incorporated in a permanent and, thus, lasting manner.

The modification step may also be carried out by jointly performing the modifications described in connection with FIGS. 7 and 8.

Of course, the embodiments of FIGS. 2 to 8 may be combined with each other (thus, for example, FIG. 2 and 7 as well as FIG. 4 and 8) where this is useful.

In the previously described embodiments, the per se insecure connection between the application 2 and the second module 3 is protected by means of the auxiliary code 9, 13. Thus, the functionality of protecting the connection between the application 2 and the second module 3 is added to the program package 1 by means of the described modification step.

Of course, a different functionality may also be added to the program package 1 by means of the added executable code 9, 13. Thus, for example, the code 9 and/or 13 may be used to individually license the function provided by the second module 3, The function provided by the second module 3 may be any function used in the application.

In many cases, a multiplicity of different second modules 3 (not shown) is provided, which are all connected to the application 2 via corresponding import/export interfaces. Each of these interfaces may be redirected as described via auxiliary codes and, thus, each second module (or each individual function of the second modules 3 provided by an export) may be licensed in a different and individual manner. This results in an extraordinarily high flexibility of licensing.

FIG. 9 schematically shows a program package 1, which comprises a first object 25 or a first class 25 and a second object or a second class 26, respectively. This may be, for example, a program package for the .net environment. The second class 26 comprises an entry point 27 of the function provided by means of the second class 26, said point being indicated in the meta data. For protection of the second class 26, the procedure is as follows. The second class 26 is stored in a further class 28 in encrypted form (as an encrypted unit 29) in the modification step, which further class 28 has the same name as the second class 26 and comprises the same interface (same signature) as class 26, so that a modified program package 1′ comprising the classes 25 and 28 is present (FIG. 10), wherein the meta data (e.g. entry point 27′) of the class 28 replace the meta data (e.g. entry point 27) of the class 26. The further class 28 includes the auxiliary code causing the desired functionality during execution.

Now, if during execution of the program via the first class 25 the second class and thus the further class 28 is requested, the latter is loaded and executed. During execution, the encrypted unit 29 is decrypted by the auxiliary code and is provided as a further object 30. Thus, the class 28 serves as a proxy for the decrypted class 30 (FIG. 11), because the executive path runs via the class 28. Prior to decryption, license verification may be carried out, for example. In this case, too, the externally visible reference (meta data concerning the entry point 27) is used in the modification step (from FIG. 9 to FIG. 10) in order to permanently embed the redirection to the auxiliary code (class 28) as well as to permanently embed the addition itself into the program package so that a modified program package 1′ is present (FIG. 10).

The above-described procedures may also be applied within a single module of a program package.

Further, prior to the described determining step wherein the externally visible reference (e.g. import or export) is determined, and prior to the modification step, wherein, for example, the import and/or export table is modified, a step of generating the executable program package (or an executable module, respectively) may also be provided, said step being adapted to generate an externally visible reference which points to the function of the module or of the program package, respectively, during generation (for example, when compiling auxiliary code in machine code). This may comprise conventionally already generated references, such as, for example, import or export tables. However, it is also possible to design the manufacturing or compiling process such that additional information (meta data) is generated which may be used as a reference to the function. Said meta data can be permanently contained in the executable program package or the executable module, respectively, or may not be a permanent part thereof.

In the following, a further embodiment will be described. As schematically shown in FIG. 12, an executable program package 51 comprises an executable application 52 to be protected (first module, in the form of an EXE file for Windows operating systems in this case) and an executable second module 53 (in the form of a DLL file in this case).

The application 52 provides a function to the second module 53 via an import/export interface. This is schematically indicated in that the application 52 comprises an export 54 and the second module 53 comprises an import 55. The connection is symbolized by the broken line 56.

The necessary data or meta data for this import/export interface 56 are stored in a known manner in the application 52 and in the second module 53 in an import table T11 in the second module 53 as well as in an export table T12 in the application 52 (indicated by arrows P11 and P12). Both the import and the export tables T11, T12 are visible from the outside and, therefore, form an externally visible reference of the function provided to the second module 53. This means that, although the application 52 and the second module 53 are present in a compiled and thus executable form, the import and export tables T11, T12 can be read out from the outside without any problem due to the known structure.

In the presently described example, the second module 53 serves to verify the presence of a license for execution of the application 52, but in turn requires a function F provided by the application 52.

While loading the application 52 and the second module 53, it may happen, depending on the run-time environment, that the function F of the application 52 is needed to initialize the second module 53. Since the application 52 has not been started yet at this time, the function F needs to be present in an executable form, i.e. unencrypted. However, the remaining regions of the application 52 are encrypted, as indicated by shaded regions.

According to the invention, a modification step is then carried out, in which the function F is encrypted (indicated by horizontal shading), auxiliary code 59 is added to the application 52 and a redirection 60 to the auxiliary code 59 is stored on the basis of the reference (export table T12). This is presently realized by modifying the export table accordingly such that a modified export table T12′ is present. On the whole, the export table is thus modified, auxiliary code 59 is added and a redirection 60 is provided in the application. Therefore, the auxiliary code 59 comprises its own export 61 replacing the previous export 54 and enabling a connection 62 to the import 55 of the second module 53, so that a modified application 52′ and, thus, also a modified program package 51′ is present (FIG. 13).

If, during initialization of the second module 53, the function F is then requested, this request is redirected to the auxiliary code 59 due to the modified export table T12′, which code executes encryption of the region of the function F and then causes execution of the function F. Thus, the method according to the invention ensures that even a request of the function F of the application 52′ during initialization of the second module 53 (i.e. even prior to the start or the execution, respectively, of the first instruction of the application 52′) can be carried out, although the function F is present in encrypted form.

Thus, the program package 51 of FIG. 13 is transformed into a modified program package 51′ by the method according to the invention (FIG. 13), wherein the modification of the export table, the encryption of the function F as well as the addition of the auxiliary code 59 are present in a permanent and lasting manner.

FIG. 14 shows an example of a modified program package 51′, again generated on the basis of the program package 51 of FIG. 12. In the modification step, encryption was not effected for the entire segment (part of the beginning of the function remains unencrypted) of the function F (horizontal shading) and auxiliary code 59 was added. The redirection to the auxiliary code 59 was not realized, however, as in the example of FIG. 13, by modifying the export table T12, but instead, the starting point of the function F was determined on the basis of the externally visible reference of the function of the application 52, and at least one additional instruction was provided at this starting point, said additional instruction at least partially replacing an original instruction of the function and effecting redirection to the auxiliary code 59, as indicated by the arrow 63. The application 52′ and, thus, also the program package 51′ are present in a modified form.

This means that also in this example, when requesting the function F already during initialization of the second module 53, prior to execution of the first instruction of the application 52, the permanently embedded redirection 63 causes the auxiliary code 59 to be executed. Thus, the auxiliary code 59 gains control over the application and can thus decrypt the function F. The auxiliary code 59 is preferably designed such that it first executes a license verification and causes decryption of the function and execution of the function F only if the license is present.

FIG. 15 shows a modified program package 51′, wherein the second module 53 is completely integrated into the application 52′. This obviates the problem of initializing the second module 53 before execution of the application 52′, and the entire application 52′ (including the function F) and also the second module 53 can be encrypted, as shown by the inserted shading. The auxiliary code 59, added to the application 52′, serves to effect the required decryption. Preferably, a license verification is also carried out here before decryption.

Of course, the application 52 to be protected need not be already partially encrypted, as is the case in the above exemplary embodiments. It may be completely unencrypted, and encryption of the application 52 is carried out together with the encryption of the function F.

1-23. (canceled)

24. A method of adding a functionality to an executable first module of a program package, wherein the executable first module, during execution, provides an internal function or utilizes an internal function of an executable second module of the program package;
wherein, when the first module is not executed, an externally visible reference pointing to said internal function is determined,
auxiliary code is added to the first module and
a redirection is permanently provided in the first module as a function of the reference thus determined such that a modified executable first module is present, wherein, when the internal function is requested during execution, a redirection is made to the auxiliary code which causes the functionality to be provided during execution.

25. The method as claimed in claim 24, wherein determination of the reference is effected when the first module is loaded into a computer, but not for execution of the module in the computer.

26. The method as claimed in claim 24, wherein the reference is determined by means of at least one meta datum, which is part of the executable program package.

27. The method as claimed in claim 24, wherein the reference is determined by means of at least one meta datum which is not part of the executable program package and has been generated during manufacture of at least one of the first and second module.

28. The method as claimed in claim 24, wherein the first module comprises an export table in which a pointer pointing to the starting point of the function in the first module is stored as a reference, the redirection to the added auxiliary code being stored in the export table.

29. The method as claimed in claim 24, wherein, for redirection to the auxiliary code in the region of the module in which instructions of the provided function are located, further code pointing to the added auxiliary code is provided.

30. The method as claimed in claim 24, wherein the first module comprises an import table in which a pointer pointing to the function of the second module is stored as a reference, the redirection to the added auxiliary code being stored in the import table.

31. The method as claimed in claim 24, wherein the first module comprises an import table in which a pointer pointing to the function of the second module is stored as a reference, wherein the pointer pointing to the import table is deleted and in the first module a request of the function is redirected to the auxiliary code as a redirection.

32. The method as claimed in claim 24, wherein the added auxiliary code establishes an interface between the two modules when starting the first module or when requesting the function.

33. 10. The method as claimed in claim 24, wherein auxiliary code is inserted which, during execution, ensures that a connection is present between the two modules without interposition of a further module.

34. The method as claimed in claim 24, wherein the redirection as well as code realizing the function are integrated into the first module itself.

35. The method as claimed in claim 4, wherein the functionality consists in protecting an interface between the two modules, wherein, in particular, a corresponding auxiliary code is inserted also in the second module.

36. The method as claimed in claim 24, wherein the functionality causes verification of a license of at least one element of the group comprising the first module, the second module and the internal function.

37. The method as claimed in claim 24, wherein the program package including the not yet modified first module is produced such that after its production the externally visible reference which points to the function is present.

38. The method as claimed in claim 24, wherein the second module uses the function provided by the first module during initialization of the second module even prior to execution of the first instruction of the first module and the added functionality is that of protecting the first module,
wherein, when the first module is not being executed and is not loaded into a computer for execution, at least part of the code of the first module realizing the function is encrypted, such that a modified first module is present, in which, if the program package including the modified first module is being executed, when requesting the function, the executive path is redirected due to the redirection to the auxiliary code which, during its execution, decrypts the encrypted code of the function such that the function can be executed.

39. The method as claimed in claim 38, wherein the first module comprises an export table in which a pointer pointing to the starting point of the function in the first module is stored as a reference, wherein the redirection to the added auxiliary code is stored in the export table.

40. The method as claimed in claim 38, wherein, for redirection to the auxiliary code in the first module, further code pointing to the added auxiliary code is provided in the region in which instructions of the provided function are located.

41. The method as claimed in claim 38, wherein auxiliary code is added which performs a license verification prior to decryption and allows decryption only if the presence of a license is determined during said license verification.

42. The method as claimed in claim 38, wherein auxiliary code is added, which stores data transmitted during request of the function and transmits them to the function after decryption.

43. The method as claimed in claim 38, wherein the auxiliary code contains a return instruction pointing to the decrypted function.

44. A method of protecting an executable first module of a program package,
wherein the first module provides a function, including an externally visible reference, to an executable second module using the function during its initialization even prior to execution of the first instruction of the first module, wherein
at least part of the code of the first module realizing the function is encrypted, executable auxiliary code is added to the first module and a redirection to the auxiliary code is provided in the first module on the basis of the reference, such that a modified first module is present, in which, when the program package including the modified first module is being executed, when requesting the function, the executive path is redirected due to the redirection to the auxiliary code which, during its execution, decrypts the encrypted code of the function such that the function can be executed.

45. The method as claimed in claim 44, wherein the redirection to the auxiliary code is provided in a permanent manner.
